(19) United States
(12) Patent Application Publication
(10) Pub. No.: US 2010/0262813 A1
(43) Pub. Date: Oct. 14, 2010

(54) Detecting and Handling Short Forward Branch Conversion Candidates

(75) Inventors: Mary D. Brown, Austin, TX (US); Richard W. Doing, Raleigh, NC (US); Kevin N. Magill, Raleigh, NC (US); Brian R. Mestan, Austin, TX (US); Wolfram M. Sauer, Austin, TX (US); Balaram Sinharoy, Poughkeepsie, NY (US); Jeffrey R. Summers, Raleigh, NC (US); Albert J. Van Norstrand, JR., Round Rock, TX (US)

Correspondence Address: IBM CORP. (WIP);c/o WALDER INTELLECTUAL PROPERTY LAW, P.C., 17330 PRESTON ROAD, SUITE 100B, DALLAS, TX, 75252, US

(73) Assignee: International Business Machines Corporation, Armonk, NY (US)

(21) Appl. No.: 12/423,608

(22) Filed: Apr. 14, 2009

(51) Int. Cl. G06F 9/38

(52) U.S. Cl. 712/240; 712/234; 712/E09.045

(57) ABSTRACT

Mechanisms, in a processor, are provided for detecting and handling short forward branch conversion candidates. The mechanisms identify a conditional branch in the computer code and determine if the short forward conditional branch is to be converted to a non-branching conditional sequence of instructions. Moreover, the mechanisms convert the conditional branch to a non-branching conditional sequence of instructions comprising a resolve instruction and one or more conditional instructions dependent on the resolve instruction. In addition, the mechanisms execute the non-branching conditional sequence of instructions in place of the conditional branch in the computer code and generate an output of the computer code based on the execution of the non-branching conditional sequence of instructions.

### BACKGROUND

The present application relates generally to an improved data processing apparatus and method and more specifically to mechanisms for detecting short forward branch conversion candidates and performing conditional conversion of selected candidates into branchless internal instruction sequences.

Branch instructions represent a large source of overhead costs when executing computer code in a pipelined processor. In modern microprocessor architectures, branch instructions are typically subject to speculative execution. With speculative execution involves predicting which branch of a branch instruction is most likely to be taken during the execution of the program code and fetching and processing instructions along this predicted branch before the branch instruction itself is actually resolved. If the prediction is correct, the processor operates in a more efficient manner in that dependent instructions are already fetched and being processed within the processor pipeline. However, if the prediction is incorrect, the instructions in the processor pipeline must be flushed and any changes made by such dependent instructions must be rolled back or otherwise invalidated. The costs associated with branch misprediction are quite substantial.

Many branch instructions in computer code are hard to predict and thus, result in a relatively large number of branch mispredictions and associated costs. It would be beneficial to minimize such branch mispredictions so as to make the processor operation more efficient.

### SUMMARY

In one illustrative embodiment, a method, in a processor, is provided for executing a computer code. The method comprises identifying, in pre-decode logic of the processor, a conditional branch in the computer code and determining, by an instruction dispatch unit of the processor, if the conditional branch is to be converted to a non-branching conditional sequence of instructions. The method further comprises converting, in decode logic of the processor, the conditional branch to a non-branching conditional sequence of instructions comprising a resolve instruction and one or more conditional instructions dependent on the resolve instruction. Moreover, the method comprises executing, in execution logic of the processor, the non-branching conditional sequence of instructions in place of the conditional branch in the computer code. In addition, the method comprises generating, by the processor, an output of the computer code based on the execution of the non-branching conditional sequence of instructions.

In another illustrative embodiment, a processor is provided. The processor may comprise pre-decode logic, an instruction dispatch unit coupled to the pre-decode logic, decode logic coupled to the instruction dispatch unit, and execution logic coupled to the decode logic. The pre-decode logic identifies a conditional branch in the computer code. The instruction dispatch unit determines if the conditional branch is to be converted to a non-branching conditional sequence of instructions. The decode logic converts the conditional branch to a non-branching conditional sequence of instructions comprising a resolve instruction and one or more conditional instructions dependent on the resolve instruction. The execution logic executes the non-branching conditional sequence of instructions in place of the conditional branch in the computer code. The processor generates an output of the computer code based on the execution of the non-branching conditional sequence of instructions.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will best be understood by reference to the following detailed description of illustrative embodiments when read in conjunction with the accompanying drawings, wherein:

FIG. 1 is a pictorial representation of an example distributed data processing system in which aspects of the illustrative embodiments may be implemented;

FIG. 2 is a block diagram of an example data processing system in which aspects of the illustrative embodiments may be implemented;

FIG. 3 is a block diagram of a processor architecture in which exemplary aspects of the illustrative embodiments may be implemented;

FIG. 4 is an exemplary block diagram illustrating an overview of a mechanism for converting short conditional forward branches to non-branching sequences of instructions in accordance with one illustrative embodiment;

FIG. 5 is an exemplary block diagram illustrating the manner by which the values in these fields of the queue structures are used in accordance with the illustrative embodiments;

FIG. 6 is an exemplary diagram illustrating a separate hardware table structure for determining predictability of short forward conditional branches in accordance with one illustrative embodiment;

FIG. 7 is a flowchart outlining an exemplary overall operation for handling branch instructions in accordance with one illustrative embodiment; and

FIG. 8 is a flowchart outlining an exemplary operation for using fields in a branch issue queue and separate non-shifting conditional instruction queue to facilitate sequencing of the resolve and dependent conditional instructions in accordance with one illustrative embodiment.

### DETAILED DESCRIPTION

The illustrative embodiments provide a mechanism for detecting short forward branch conversion candidates and performing conditional conversion of selected candidates into branchless internal instruction sequences. With the mechanisms of the illustrative embodiments, unpredictable short conditional forward branches, e.g., short “if” statements, are detected and analyzed to determine if these short conditional forward branches may be converted to non-branching conditional sequences. For example, the non-branching conditional sequences may involve a non-branching “resolve” instruction and one or more conditional instructions. The execution of the conditional instructions is dependent on the “resolve” instruction execution. Thus, rather than executing a branch instruction which, with speculative processors, may result in branch mispredictions that involve considerable processor overhead to resolve, the non-branching conditional sequence is not susceptible to such mispredictions.

While conversion of a short forward branch into a non-branching conditional sequence avoids the cost of redirecting the branch, i.e. due to a branch misprediction, this conversion introduces new dependencies into the instruction stream by the non-branching conditional sequence, i.e. the conditional instructions are dependent on the “resolve” instruction. If the original branch is highly predictable, the cost of converting to the non-branching conditional sequence is much higher than the benefit obtained, i.e. since branch misprediction is less likely with highly predictable branches.

The illustrative embodiments provide mechanisms for using saturating counters of a Branch History Table (BHT) to predict when a short-forward branch is unpredictable and thus, would benefit from conversion to a non-branching conditional sequence. That is, when a branch instruction is in the execution stage of a processor pipeline, and it is determined to be a candidate for conversion, the branch execution unit (BRU) of the processor may check the BHT counters. If the counters suggest a low confidence and the BRU mispredicts the branch, then the BHT is written with a special conversion code. This code is used by the decoder unit of the processor to convert the branch to a non-branching conditional sequence the next time it is fetched from the instruction cache. Using the BHT in this way makes efficient use of existing resources and avoids the added cost of having specific tables to track prediction history.

The special code that is written to the BHT when the BRU mispredicts and the counters suggest a low confidence for the branch instruction may be a combination of the saturation counter values. For example, if there are 3 BHTs, e.g., a local predictor BHT, a global predictor BHT, and a selector predictor BHT, in the system, each with a 2-bit counter, the special code may be a 6-bit string derived from the 2-bit local counter, 2-bit global counter, and 2-bit selector. In order to avoid aliasing, the special code may be chosen such that it does not frequently or naturally occur in the system.

When the instruction dispatch unit of the processor receives a short branch instruction out of the instruction cache, it may check the BHT bits corresponding to short branch instruction. If the special code is detected, the instruction dispatch unit may set a bit to inform the downstream decoder unit to convert this branch instruction into a non-branching conditional sequence. Branch instructions that are converted to non-branching conditional sequences of instructions are referred to herein as “cracked” instructions and the bit that is set by the instruction dispatch unit to inform the decoder unit to convert the branch instruction is referred to as the “cracked instruction” bit.

Additional mechanisms are provided in illustrative embodiments of the present invention for performing instruction sequencing of non-branching resolve and dependent conditional instructions. Furthermore, mechanisms are provided for performing a conditional store instruction such that the issuing of a store instruction is supported while providing the branch execution unit (BRU) with an opportunity to later indicate the need to suppress the store instruction's effects. In still further illustrative embodiments, rather than using the BHT to identify unpredictable short forward branches for conversion to non-branching conditional sequences, separate table structures may be provided to identify unpredictable short forward branches as candidates for conversion. Such separate table structures may utilize effective address tag bits, thread bits, and saturating counters to perform identification of unpredictable short forward branches that are to be converted to non-branching conditional sequences.

Conversion of short forward branches, by the mechanisms of the illustrative embodiments, is a technique to avoid the penalty of mispredicted branches, by conditionally executing one or more instructions that are conditionally dependent on the branch condition. Conversion is particular effective if the branch cannot be predicted easily. If the branch is highly predictable, no branch redirect penalty can be saved by conversion and thus, conversion may result in a negative impact on performance. It is therefore, important to limit the conversion technique to short forward branches with a high number of mispredictions. Hardware mechanisms, as described above, e.g., saturation counters and the BHT, are provided to determine the predictability of a branch and determine whether conversion should be performed.

In addition to these hardware mechanisms, in some illustrative embodiments, a compiler may be used to identify branch behavior to determine which short forward branches are candidates for conversion using the mechanisms of the illustrative embodiments. For example, the compiler may determine that a conditional branch to compute the maximum of two values is hard to predict, assuming random parameters. An even more reliable method of determining branch behavior is runtime profiling of the instructions.

In both cases, a hint may be supplied to the hardware to indicate that a branch is probably hard to predict. For example, in the POWER PC™ architecture, the conditional branch instruction (bc BO, BI, target_address) may receive a hint by using a reserved setting of the “at” bits in the BO field (“01” is currently a reserved value). If the hardware decodes the special hint bit value, it automatically converts the short branch and its target instruction(s) without consulting its internal indicator for predictability, i.e. the BHT or other separate table structures. In addition, or alternatively, a special value may be used to suppress conversion independent of the prediction mechanisms.

As will be appreciated by one skilled in the art, the present invention may be embodied as a system, method, or computer program product. Accordingly, the present invention may take the form of an entirely hardware embodiment, an entirely software embodiment (including firmware, resident software, micro-code, etc.), or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example, but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, radio frequency (RF), etc.

Computer program code for carrying out operations of the present invention may be written in any combination of one or more programming languages, including an object oriented programming language such as Java™, Smalltalk™, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In addition, the program code may be embodied on a computer readable storage medium on the server or the remote computer and downloaded over a network to a computer readable storage medium of the remote computer or the users' computer for storage and/or execution. Moreover, any of the computing systems or data processing systems may store the program code in a computer readable storage medium after having downloaded the program code over a network from a remote computing system or data processing system.

The illustrative embodiments are described below with reference to flowchart illustrations and/or block diagrams of methods, apparatus (systems) and computer program products according to the illustrative embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

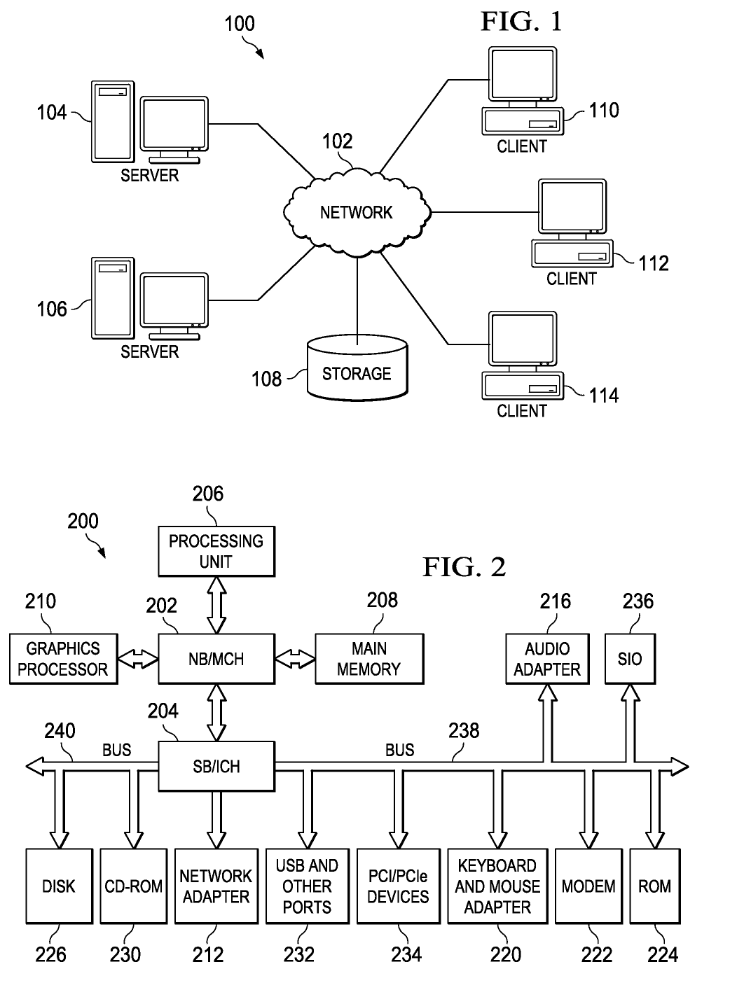

The illustrative embodiments may be utilized in many different types of data processing environments including a distributed data processing environment, a single data processing device, or the like. In order to provide a context for the description of the specific elements and functionality of the illustrative embodiments, FIGS. 1 and 2 are provided hereafter as example environments in which aspects of the illustrative embodiments may be implemented. While the description following FIGS. 1 and 2 will focus primarily on a single data processing device implementation, this is only an example and is not intended to state or imply any limitation with regard to the features of the present invention. To the contrary, the illustrative embodiments are intended to include distributed data processing environments and embodiments in which the mechanisms of the illustrative embodiments may be implemented.

With reference now to the figures and in particular with reference to FIGS. 1-2, example diagrams of data processing environments are provided in which illustrative embodiments of the present invention may be implemented. It should be appreciated that FIGS. 1-2 are only examples and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 is a pictorial representation of an example distributed data processing system in which aspects of the illustrative embodiments may be implemented. Distributed data processing system 100 may include a network of computers in which aspects of the illustrative embodiments may be implemented. The distributed data processing system 100 contains at least one network 102, which is the medium used to provide communication links between various devices and computers connected together within distributed data processing system 100. The network 102 may include connections, such as wire, wireless communication links, or fiber optic cables.

In the depicted example, server 104 and server 106 are connected to network 102 along with storage unit 108. In addition, clients 110, 112, and 114 are also connected to network 102. These clients 110, 112, and 114 may be, for example, personal computers, network computers, or the like. In the depicted example, server 104 provides data, such as boot files, operating system images, and applications to the clients 110, 112, and 114. Clients 110, 112, and 114 are clients to server 104 in the depicted example. Distributed data processing system 100 may include additional servers, clients, and other devices not shown.

In the depicted example, distributed data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed data processing system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

With reference now to FIG. 2, a block diagram of an example data processing system is shown in which aspects of the illustrative embodiments may be implemented. Data processing system 200 is an example of a computer, such as client 110 in FIG. 1, in which computer usable code or instructions implementing the processes for illustrative embodiments of the present invention may be located.

In the depicted example, data processing system 200 employs a hub architecture including north bridge and memory controller hub (NB/MCH) 202 and south bridge and input/output (I/O) controller hub (SB/ICH) 204. Processing unit 206, main memory 208, and graphics processor 210 are connected to NB/MCH 202. Graphics processor 210 may be connected to NB/MCH 202 through an accelerated graphics port (AGP).

In the depicted example, local area network (LAN) adapter 212 connects to SB/ICH 204. Audio adapter 216, keyboard and mouse adapter 220, modem 222, read only memory (ROM) 224, hard disk drive (HDD) 226, CD-ROM drive 230, universal serial bus (USB) ports and other communication ports 232, and PCI/PCIe devices 234 connect to SB/ICH 204 through bus 238 and bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

HDD 226 and CD-ROM drive 230 connect to SB/ICH 204 through bus 240. HDD 226 and CD-ROM drive 230 may use, for example, an integrated drive electronics (IDE) or serial advanced technology attachment (SATA) interface. Super I/O (SIO) device 236 may be connected to SB/ICH 204.

An operating system runs on processing unit 206. The operating system coordinates and provides control of various components within the data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java™ programs or applications executing on data processing system 200 (Java is a trademark of Sun Microsystems, Inc. in the United States, other countries, or both).

As a server, data processing system 200 may be, for example, an IBM® eServer™ System p® computer system, running the Advanced Interactive Executive (AIX®) operating system or the LINUX® operating system (eServer, System p, and AIX are trademarks of International Business Machines Corporation in the United States, other countries, or both while LINUX is a trademark of Linus Torvalds in the United States, other countries, or both). Data processing system 200 may be a symmetric multiprocessor (SMP) system including a plurality of processors in processing unit 206. Alternatively, a single processor system may be employed.

Instructions for the operating system, the object-oriented programming system, and applications or programs are located on storage devices, such as HDD 226, and may be loaded into main memory 208 for execution by processing unit 206. The processes for illustrative embodiments of the present invention may be performed by processing unit 206 using computer usable program code, which may be located in a memory such as, for example, main memory 208, ROM 224, or in one or more peripheral devices 226 and 230, for example.

A bus system, such as bus 238 or bus 240 as shown in FIG. 2, may be comprised of one or more buses. Of course, the bus system may be implemented using any type of communication fabric or architecture that provides for a transfer of data between different components or devices attached to the fabric or architecture. A communication unit, such as modem 222 or network adapter 212 of FIG. 2, may include one or more devices used to transmit and receive data. A memory may be, for example, main memory 208, ROM 224, or a cache such as found in NBAMCH 202 in FIG. 2.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the illustrative embodiments may be applied to a multiprocessor data processing system, other than the SMP system mentioned previously, without departing from the spirit and scope of the present invention.

Moreover, the data processing system 200 may take the form of any of a number of different data processing systems including client computing devices, server computing devices, a tablet computer, laptop computer, telephone or other communication device, a personal digital assistant (PDA), or the like. In some illustrative examples, data processing system 200 may be a portable computing device which is configured with flash memory to provide non-volatile memory for storing operating system files and/or user-generated data, for example. Essentially, data processing system 200 may be any known or later developed data processing system without architectural limitation.

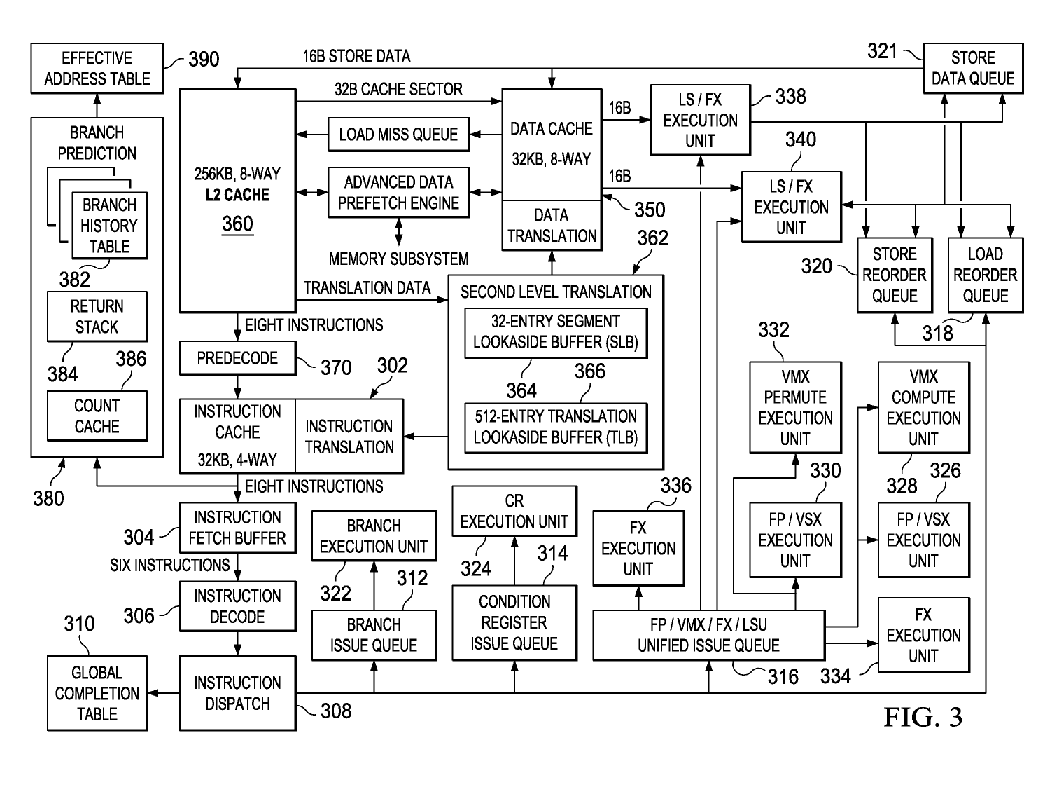

FIG. 3 is a block diagram of a processor architecture in which exemplary aspects of the illustrative embodiments may be implemented. As shown in FIG. 3, the processor architecture includes an instruction cache 302, an instruction fetch buffer 304, an instruction decode unit 306, and an instruction dispatch unit 308. Instructions are fetched by the instruction fetch buffer 304 from the instruction cache 302 and provided to the instruction decode unit 306. The instruction decode unit 306 decodes the instruction and provides the decoded instruction to the instruction dispatch unit 308. The output of the instruction dispatch unit 308 is provided to the global completion table 310 and one or more of the branch issue queue 312, the condition register issue queue 314, the unified issue queue 316, the load reorder queue 318, and/or the store reorder queue 320, depending upon the instruction type as determined through the decoding and mapping of the instruction decode unit 306. The issue queues 312-320 provide inputs to various ones of execution units 322-340. Data for use with the instructions may be obtained via the data cache 350 and the register files contained with each respective unit.

The instruction cache 302 receives instructions from the L2 cache 360 via the second level translation unit 362 and pre-decode unit 370. The second level translation unit 362 uses its associates segment lookaside buffer 364 and translation lookaside buffer 366 to translate addresses of the fetched instruction from effective addresses to system memory addresses. The pre-decode unit partially decodes instructions arriving from the L2 cache and augments them with unique identifying information that simplifies the work of the downstream instruction decoders.

The instructions fetched into the instruction fetch buffer 304 are also provided to the branch prediction unit 380 if the instruction is a branch instruction. The branch prediction unit 380 includes a branch history table 382, return stack 384, and count cache 386.

The EA and associated prediction information from the branch prediction unit are written into the Effective Address Table 390. This EA will later be confirmed by the branch execution unit 322. If correct, it will remain in the table until all instructions from this address region have completed their execution. If incorrect, the branch execution unit will flush out the address and the corrected address will be written in its place.

Instructions that read from or write to memory (such as load or store instructions) are issued to the LS/EX execution unit 338, 340. The LS/EX execution unit 338, 340 retrieves data from the data cache 350 using a memory address specified by the instruction. This address is an effective address and needs to first be translated to a system memory address via the second level translation unit before being used. If an address is not found in the data cache, the load miss queue is used to manage the miss request to the L2 cache. In order to reduce the penalty for such cache misses, the advanced data prefetch engine predicts the addresses that are likely to be used by instructions in the near future. In this manner, data will likely already be in the data cache when an instruction needs it, thereby preventing a long latency miss request to the L2 cache.

The LS/EX execution unit 338, 340 is able to execute instructions out of program order by tracking instruction ages and memory dependences in the load reorder queue 318 and store reorder queue 320. These queues are used to detect when out-of-order execution generated a result that is not consistent with an in-order execution of the same program. In such cases, the current program flow must be flushed and performed again.

The illustrative embodiments provide logic that may be implemented in one or more of the elements shown in FIG. 3 to identify short conditional forward branches that are candidates for conversion to non-branching conditional sequences of instructions. Short conditional forward branches are branch instructions which operate to skip over one or a relatively small number of instructions when the branch is taken or not taken, depending on the particular situation. The particular number of instructions that are considered “relatively small” may be implementation dependent and may be a setting that is pre-determined and stored as a parameter or otherwise hardwired into the processor hardware. For example, a branch that skips 5 instructions if taken (or not taken) is relatively smaller than a branch that skips 100 instructions if taken (or not taken). The particular threshold between relatively small and not relatively small may be empirically determined and used to configure the mechanisms of the illustrative embodiments for identifying short conditional forward branches as candidates for conversion using the other mechanisms of the illustrative embodiments.

Short conditional forward branches are typically generated by compilers to represent short “if” statements, built-in functions, and other constructs. For example, the if statement “if (x>10) count_{—}10++;” translates into the following machine code:

| | | |
|---|---|---|
| cmpi | r5, 10 | Compare r5(x) to 10 |
| bne | +8 | Skip next instruction, if not equal |
| addi | r23, 1 | Increment r23(count_10) |
| . . . | | Continue |

As another example, the statement “a=max(a, b);” translates into the following machine code:

| | | |
|---|---|---|
| cmp | r12, r3 | Compare r12(a) to r3(b) |
| bge | +8 | Skip next instruction, if a >= b |
| mr | r12, r3 | Move content of r3(b) to r12(a) |
| . . . | | Continue |

In general, the instruction being skipped can be any type of instruction or short sequence of instructions. Note that the examples above refer instructions in the POWER PC™ Instruction Set Architecture (ISA) available from International Business Machines Corporation of Armonk, N.Y. However, the illustrative embodiments are not limited to use with the POWER PC™ ISA and may be utilized with other instruction set architectures and other processor architectures without departing from the spirit and scope of the illustrative embodiments.

Some of the short conditional forward branches are hard to predict for the hardware branch prediction mechanisms, e.g. branch prediction unit 380. That is, the predictions result in a large number of branch mispredictions, flushing of the processor pipeline, etc. In the first example above, assuming x rarely equals 10, the branch will mostly be taken and is very well predictable by the hardware prediction mechanisms. However, in the second example, assuming random distribution of values for a and b, the branch is unpredictable for any hardware branch prediction mechanism. The costs of mispredicting such branches depends on the processor microarchitecture, but is generally high for modern high performance microprocessors.

One mechanism for avoiding the branch altogether is to use instruction predication. With instruction predication, each instruction carries a predicate value which determines if the instruction is executed at run time. The predicate value is set by a previous compare operation or other logical operation. While predication may help to avoid the costs of branch misprediction, predication is very expensive to implement, especially for existing processor architectures that do not support the concept.

The illustrative embodiments provide mechanisms for avoiding the branch misprediction costs or penalties for short conditional forward branches without requiring the expensive implementation of predication. With the mechanisms of the illustrative embodiments, unpredictable short conditional forward branches are dynamically detected and converted into equivalent non-branching sequences within the microprocessor, i.e. by the hardware of the microprocessor. The new non-branching sequences employ non-branching “resolve” instructions and one or more conditional instructions. The execution of the conditional instructions is dependent on the “resolve” instruction execution. A compiler hint may be added to the instruction set architecture to assist in the determination of unpredictable short conditional forward branches.

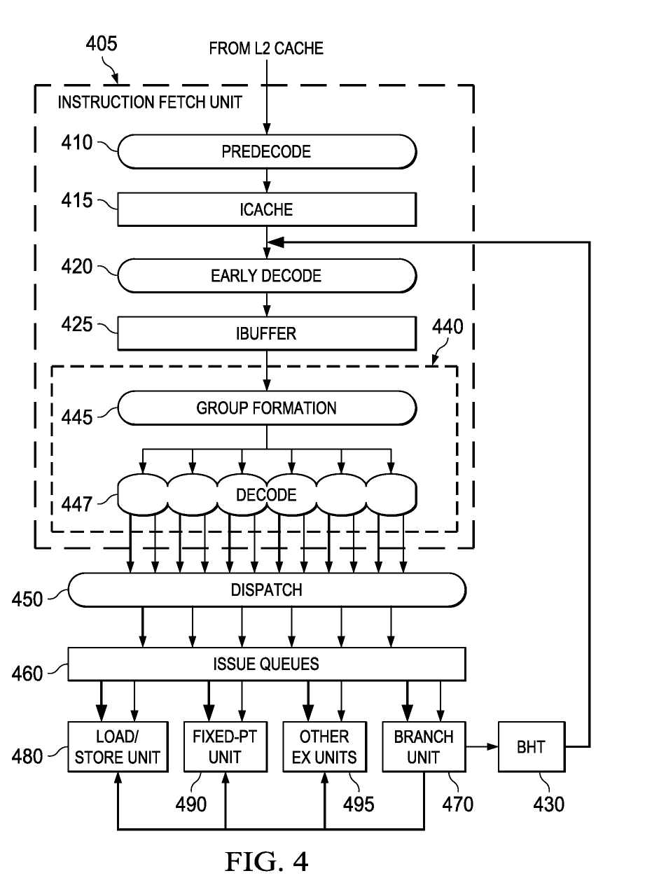

FIG. 4 is an exemplary block diagram illustrating an overview of a mechanism for converting short conditional forward branches to non-branching sequences of instructions in accordance with one illustrative embodiment. As shown in FIG. 4, and with continued reference to similar elements shown in FIG. 3, an instruction is read from the L2 cache 360 by the pre-decode logic 410. With the mechanisms of the illustrative embodiments, the pre-decode logic 410 is provided with logic for detecting short forward conditional branches that may be candidates for conversion to non-branching conditional sequences of instructions in accordance with the illustrative embodiments. If the pre-decode logic 410 identifies the instruction as a short forward conditional branch, a pre-decode bit for short forward conditional branches may be set. Moreover, for not-taken operations of the short forward conditional branch that support conditional execution, the pre-decode bit is also set, as described hereafter. The instructions are forwarded to the instruction cache 415.

Instructions in the instruction cache 415 are processed by early decode logic 420. The early decode logic 420 performs a lookup of the branch instructions in the instruction cache 415 in the branch history table (BHT) 430, which may be provided in a branch prediction unit of the processor architecture. As discussed in further detail hereafter, entries in the BHT 430 may contain information about whether or not an associated branch has been taken in the past as well as other information to allow the branch prediction unit to determine whether the branch should be predicted to be taken or not taken when the branch instruction is processed. BHTs and their use with branch prediction are generally known in the art.

In accordance with the illustrative embodiments herein, the entries in the BHT 430 may further be written with a special code under certain circumstances so as to inform the early decode logic 420 that associated branches are to be converted to non-branching conditional sequences of instructions. Thus, when the early decode logic 420 performs a lookup of the branch instruction, e.g., the branch instruction opcode or other identifier, in the BHT 430, if the early decode logic 420 detects the special code being present in the entry, the early decode logic 420 may notify group formation logic 445 of instruction decode logic 440 that the short forward conditional branch instruction should be converted, or “cracked,” into a non-branch conditional sequence equivalent. Such notification may be made, for example, by setting a “cracked bit” in an instruction buffer entry of the instruction buffer 425 corresponding to the short forward branch instruction.

When the group formation logic 445 retrieves the instruction from the instruction buffer 425, the group formation logic 445 accesses the cracked bit in the instruction buffer entry of the instruction buffer 425. If the cracked bit is set, i.e. the short forward branch instruction has been determined to be one that should be converted to a non-branching conditional sequence of instructions, then the group formation logic 445 converts the short forward conditional branch instruction to a conditional execution group. The conditional execution group is comprised of a resolve instruction and non-branching conditional statements corresponding to the non-taken instructions associated with the short forward conditional branch, which are dependent upon the resolve instruction. The group formation logic 445 may transmit a signal to the instruction sequencing unit (ISU) 460 comprising the issue queues 465, informing the ISU 460 that the group of instructions being sent to the ISU 460 is a conditional execution group.

The conditional execution group is sent to the instruction decode logic 447 which decodes the instructions in the conditional execution group and provides the instructions to instruction dispatch logic 450. The instruction dispatch logic 450 dispatches the instructions to the issue queues 465 of the ISU 460. The ISU 460 marks the not-taken operations (now converted to equivalent conditional instructions) as being dependent on a not-taken result of the resolve instruction in the conditional execution group. The issue queues 465 issue/kill the instructions to corresponding execution units 470-495 with taken (T)/not taken (NT) dependencies being tracked. Not-taken instructions are killed based on results of the processing of the resolve instruction due to their dependency.

The branch execution unit (BRU) 470 is responsible for sending out a taken/not taken bit for the resolve instruction. The BRU 470 also looks for opportunities to convert short conditional branch instructions to non-branching conditional sequences of instructions, as described in greater detail hereafter. The BRU 470 writes the special code to the BHT 430 entry corresponding to a short conditional branch instruction that has been determined to be one that should be converted to a non-branching conditional sequence of instructions.

As discussed above, the pre-decode logic 410 detects short forward conditional branch instruction candidates. The detection of such short forward conditional branch instructions may be based on pre-determined criteria, e.g. a predetermined number of “not taken” instructions associated with the branch. The “not taken” instructions are instructions of the branch that will be skipped if the condition of the branch is met. A pre-determined number of these instructions may be set in the hardware logic of the processor, e.g., in the pre-decode logic 410, as a criteria by which to select short forward conditional branch instructions as candidates for conversion to non-branching conditional sequences. The criteria may be set in terms of a branch size, e.g., a number of bytes, based on the instruction size used in the particular processor architecture. For example, if the predetermined number of instructions is 1 instruction, this may be specified as a branch size of 8 bytes (skipping 8 bytes causes one instruction of 4 bytes to be skipped) in one processor architecture.

After detecting such short forward conditional branch instruction candidates, it is dynamically determined whether such candidates should be processed using traditional branch prediction mechanisms or to convert such candidates to non-branching conditional sequences for conditional execution. Such dynamic determination may be made based on the confidence level of the short forward conditional branch. One example mechanism is to use the values stored in the BHTs to gauge confidence. The details of this exemplary mechanism are described hereafter.

The conversion of the short forward conditional branch and its not taken instructions into a non-branching conditional execution sequence avoids the cost of redirecting the branch at the expense of introducing new dependencies in the instruction stream. If the branch is highly predictable, the cost of converting will be higher than the benefit.

In many cases, the compiler typically will not be able to determine the predictability of these short forward conditional branches and thus, the hardware mechanisms of the illustrative embodiments that dynamically determine the predictability of the branch is highly desirable. With the hardware mechanisms of the illustrative embodiments, the saturating counters of the branch history table (BHT) 430 predict when a short forward conditional branch is unpredictable.

For example, consider a processor architecture that uses three different BHTs, a local predictor BHT, a global predictor BHT, and a selector predictor BHT that selects between local and global. Assume that the local and global predictors use a 2-bit saturating counter to record the taken/not taken behavior of a branch and that the selector predictor uses a 2-bit saturating counter to record which prediction table (local or global) was most accurate in the past. Consider the left-most bit of the 2-bit counter to be the direction of which to predict a branch, where if the bit is set to a value of “0”, the branch is predicted not taken and if it is set to a value of “1”, the branch is predicted as taken. Under this definition, there are two values of the counter that give a not taken prediction (“00” and “01”) and two values of the counter that give a taken prediction (“10” and “11”). Further, let “strong” refer to the counter values at the extremes (eg, a value of “00” or “11”), and “weak” refer to the counter values that are not at the extremes (eg. a value of “01” or “10”). When a counter is at a strong condition, it has seen 2 or more actions in the same direction in a row. This repetition of branch directions may provide a level of confidence. Under this scheme where more than one BHT is used, the following metrics may be used to determine the confidence of the branch:
High Confidence=((Local=Global) and (Both Strong)) or ((Local=Strong) and (Sel=Local) and (Sel=Strong)) or ((Global=Strong) and (Sel=Global) and (Sel=Strong))
Low Confidence=NOT High Confidence

The Branch Execution Unit (BRU) 470 can use the above metrics to determine when to convert a short forward conditional branch to a non-branching conditional execution sequence involving a resolve operation and dependent conditional operations. When a short forward branch conditional instruction has been determined by the pre-decode logic 410 to be a candidate for conversion, the corresponding pre-decode bit is set, cracked bit is set, etc., as described above with regard to FIG. 4. Such candidate forward branch conditional instructions, when received by the BRU 470 for execution, the BRU 470 determines checks the BHT 430 counter values to determine whether the short forward branch conditional instruction should be converted in future executions of the instruction.

In checking the BHT 430, the determination is whether the counter values in the BHT 430 indicate unpredictability of the short forward branch conditional instruction. Such unpredictability may be determined based on whether the counter values indicate a low confidence in the short forward branch conditional instruction and the BRU 470 mispredicts the branch. A branch is mispredicted when the predicted direction is different from the direction observed at execution time. In the POWERPC™ architecture a branch direction is based on the status of a Condition Register (CR). The CR is set via any condition setting instruction, such as a record or compare instruction. Such instructions compare two values and set a bit in the CR based on that comparison. For example, a register X may be compared to a register Y using a compare instruction. If X<Y, then a CR bit may be set to “1”. If the condition is not true, a CR bit may be set to “0”. A branch instruction may then test this CR bit to determine if X<Y.

The branch execution unit tests this CR value, to determine the direction of the branch. If the direction is different from how the branch was predicted, a misprediction occurs and the processor pipeline is flushed. If a misprediction occurs on a low confidence short forward branch instruction, the BRU 470 may write a special code to the entry in the BHT 430. This special code is used by the early decode logic 420 to convert the short forward branch instruction to a non-branching conditional execution sequence of instructions the next time it is fetched from the instruction cache. The BRU 470 is an ideal candidate to determine when to convert short forward conditional branch instructions as it naturally interfaces to the BHT 430 which holds the knowledge for branch prediction. Using the BHT 430 in this manner makes efficient use of the existing resources and avoids the added cost that specific tables to track prediction history would introduce.

The special code that is written to the BHT 430 entry, in one illustrative embodiment, is a combination of saturating counter values. For example, using the 3 BHTs discussed above, the special code may be a 6-bit string derived from the 2-bit local counter, 2-bit global counter, and the 2-bit selector. In order to avoid aliasing the code chosen is one that does not frequently and naturally occur. Branches are typically biased to a fixed set of BHT values and performance analysis has found that the following combination is infrequently observed across modern benchmark suites: local=“11”; global=“01”; and selector=“11.” When the early decode logic 420 receives the short forward conditional branch instruction from the instruction cache 415, the early decode logic 420 sets a cracked bit to tell the downstream instruction decode logic 440 to convert this branch into non-branching conditional execution.

Thus, the pre-decode logic 410 identifies candidate short forward conditional branch instructions and the BRU 470 determines when these short forward conditional branch instructions should be converted to non-branching conditional execution sequences of instructions based on their predictability. Thereafter, candidates that are to be converted, are converted to non-branching conditional execution sequences by the instruction decode logic 440. The conversion involves removing the original branch instruction, replacing the original branch instruction with a non-branching resolve instruction, and the replacing the “non-taken” instructions associated with the original branch instruction with equivalent conditional instructions that are dependent upon the results of the resolve instruction. The resolve operation is a branch operation that is not susceptible to a misprediction since the resolve operation only outputs a value indicative of whether the branch is taken or not taken, i.e. whether the branch condition is met or not met. The conditional instructions are dependent upon whether this resolve operation indicates that the branch is taken or not taken.

The resolve operation is similar to a normal branch operation in that its result is dependent on a condition register (CR). The resolve operation tests a CR value just as a normal branch operation, but rather than generating a misprediction, it produces a taken/not taken bit, i.e. the bit is set if the resolve operation resolves to the branch being “taken” and is not set if the resolve operation indicates that the branch is “not taken,” or vice versa.

As an example of such a conversion, consider an original short forward conditional branch instruction for a register move sequence:
bne cr2, pcplus8
ori r7, r8, 0
   where cr2 is the condition register. The bne mnemonic specifies a branch instruction that tests the “not equal” bit of cr2. The branch will be taken if the “not equal” bit in cr2 is of a value of “0”. The ori mnemonic specifies an instruction which does a logical OR operation of r8 to the value of “0” and places the result in r7. When the ori instruction is used with a value of “0” in this fashion, it is essentially a move instruction of r8 to r7 since performing a logical OR with “0” does not change the value in r8. This is a common way for a user to move the contents of one register to another. It is important to note in this example that if the bne instruction produces a taken result, then the ori instruction is skipped and r8 is not moved into r7. In this case, after this sequence, r7 maintains its old value. If the bne instruction is not taken, then r8 will be moved into r7.

Through the mechanisms of the illustrative embodiments, conversion to a non-branching resolve operation and dependent conditional instructions results in:
rslv TNT, cr2
csel r7, r7, r8, TNT
   where rslv is the resolve instruction, TNT is the taken/not taken bit, cr2 is the condition register, csel is a conditional select operation, and r7 and r8 are operand registers.

As can be seen from the above example, the resolve operation sets a taken/not taken (TNT) bit based on the condition register cr2 and the conditional select operation is further dependent upon the TNT bit. The csel is a mnemonic that specifies a conditional select instruction. This conditional select instruction moves a different register to r7 under the direction of the TNT bit. The contents of r7 are moved to r8 if the TNT bit is a “0”. The contents of r7 are moved to r7 if the TNT bit is a “1”. Overwriting r7 with its old value has essentially no observable action. R7 is simply maintaining its old value just as it did in the first instruction sequence if the branch was taken. Both instruction sequences are architecturally equivalent, but by using the mechanisms of the illustrative embodiment, the branch instruction, and its potential to cause a pipeline flush, has been eliminated.

In one illustrative embodiment, the resolve instructions are issued from a branch issue queue of the issue queues 460 to the branch execution unit (BRU) 470. The dependent conditional instructions are issued from a separate queue structure which is implemented as a non-shifting queue, meaning a given instruction stays in one entry of the queue the entire time it is in the queue. The resolve instruction tracks, i.e. stores, the queue position (qpos), in this separate non-shifting conditional instruction issue queue, of the dependent conditional instructions which depend upon it. By ensuring that both the resolve instruction and conditional instructions are in the same dispatch group, the queue position to which the conditional instructions will be dispatched can be written into the resolve instruction's queue entry without adding any extra write ports into the branch issue queue.

Each entry of the branch issue queue contains the following fields to support this operation: (1) resolve valid: indicates if the instruction is a resolve; and (2) target qpos: queue entry of the conditional instructions. There is at least one target qpos for each resolve instruction, however there may be multiple target qpos for a single resolve instruction. If there is more than one conditional instruction associated with the resolve instruction, valid bits may be added for each target qpos field after the first one. These valid bits may be set at dispatch time to indicate which target qpos fields store queue positions of conditional instructions. They are used to qualify the wakeup of the instruction in its issue queue.

Each entry of the non-shifting conditional instruction issue queue contains the at least three fields. In a first field, a conditional valid bit is provided that indicates the instruction in that queue entry is a conditional instruction. In a second field, a taken/not taken (TNT) ready value is provided that indicates whether or not the TNT bit for the resolve instruction upon which the conditional instruction is dependent has been sent from the BRU. In a third field, a TNT bit is provided that indicates if the branch converted to the resolve instruction was taken or not taken.

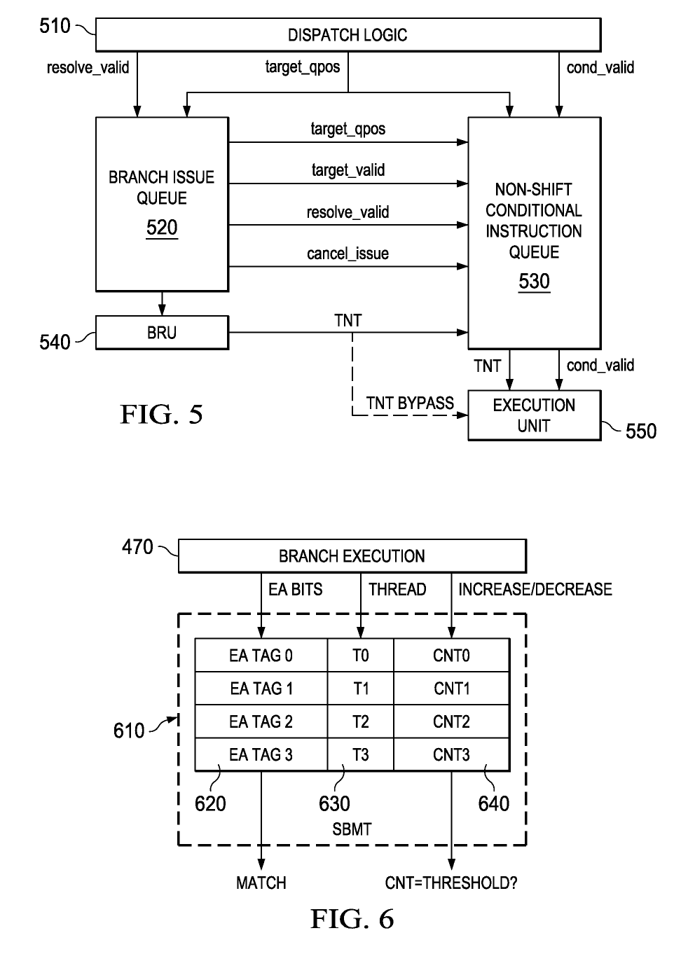

FIG. 5 is an exemplary block diagram illustrating the manner by which the values in these fields of the queue structures are used in accordance with the illustrative embodiments. When the instruction group comprising the resolve instruction and its dependent conditional instructions is dispatched by the dispatch logic 510, for the conditional instructions the conditional valid bit (cond valid) is set to “1” and the TNT ready bit is set to “0.” The conditional instruction is not ready to issue until the TNT ready bit has been set to “1.” The TNT ready bit is set to “1” after the corresponding resolve instruction is issued from the branch instruction queue 520 to the BRU 540 and ultimately to the branch execution unit. The target queue position (target_qpos) is also forwarded from the branch issue queue 520 to the non-shifting conditional instruction queue 530 when the resolve instruction is issued to the BRU 540, e.g. BRU 470 in FIG. 4. The target queue position (target_qpos) from the branch issue queue 520 is used to index or select an entry in the non-shifting conditional instruction queue 530 belonging to the dependent conditional instruction corresponding to the resolve instruction. The TNT ready bit is then set.

At substantially the same time as the indexing into the conditional instruction issue queue 530 using the target_qpos value, the TNT bit is forwarded from the BRU 540 to the non-shifting conditional instruction queue 530. The forwarded TNT bit is written into the one or more entries in the separate non-shifting conditional instruction queue 530 corresponding to the dependent conditional instructions. When the dependent conditional instruction is ready to be issued, the TNT bit is sent to the execution unit 550 along with the rest of the conditional instructions' data. If the TNT bit is set, i.e. has a value of “1” or a logic high state, indicative that the branch is taken, then the writing of the results of the execution unit's operation are inhibited. If the TNT bit is not set, i.e. has a value of “0” or a logic low state, indicative that the branch is not taken, then the writing of the results of the execution unit's operation are not inhibited.

In the operation described above, the target queue position is used to set the dependent conditional instruction's TNT ready bit. However, it may be several processor cycles from when the TNT ready bit is set to when the dependent conditional instruction can actually be issued. To reduce the number of cycles from when the resolve instruction is issued to when the dependent conditional instruction is issued, the target queue position may be used in an issue bypass, referred to as the TNT bypass. With this issue bypass, the normal wakeup/select logic in the issue queue is not used. Rather, the target queue position is used to read out the entry of the conditional instruction so that it can be issued. This issue is speculative, as the conditional instruction may need to wait for other source operands before it is ready to issue. Thus, a reject mechanism, such as is generally known in the art, can be used to support this speculation.

As is further shown in FIG. 5, the target_qpos is also sent from the dispatch logic 510 to the queues 520 and 530 and is used as the address of the conditional instruction. In queue 530, the target_qpos is used as the write address into the issue queue for the conditional instruction. In queue 520, the target_qpos is stored in the target_qpos field of the resolve instruction. When a resolve instruction gets issued, the target_qpos and target-valid bit are sent to the non-shifting conditional instruction queue 530. This target qpos and valid bit are used to wake up the conditional instruction associated with the issued resolve instruction. If the issue of the resolve instruction gets canceled for any reason, such as if it were dependent on a load that missed in the data cache and must be delayed, the cancel_issue signal is sent to the non-shifting conditional instruction queue 530, i.e. the cancel_issue signal is asserted. The conditional instruction is not issued in this case.

Thus, the illustrative embodiments provide a mechanism by which short forward conditional branches may be identified as candidates for conversion to an equivalent non-branching conditional execution sequence. Moreover, the illustrative embodiments provide mechanisms for determining whether these candidates should actually be converted or not based on an indication of whether the short forward conditional branch instruction has a low confidence and is determined to be not taken. Furthermore, mechanisms are provided for converting the candidates determined to be ones that are to be converted, into a non-branching conditional execution sequence of instructions comprising a resolve instruction and one or more dependent conditional instructions. In addition, mechanisms are provided for sequencing the resolve instruction and dependent conditional instructions using the various fields of the branch issue queue and a separate non-shifting conditional instruction queue. Moreover, mechanisms are provided for inhibiting the writing of results from execution units in the event that the original branch instruction is taken.

A processor implementing the conversion of unpredictable short forward conditional branches to non-branching conditional execution sequences of instructions needs a mechanism to identify these short forward conditional branches as being hard to predict. As described above, one way in which to do this is to use the existing BHT to provide a special code in entries corresponding to branches that are hard to predict and thus, should be converted. This has the advantage of not requiring additional hardware. However, it may restrict the capabilities of the BHT with regard to the regular usage of the BHT with regard to these branches since the information in the BHT entry is overwritten by the special code.

In an alternative illustrative embodiment, rather than using the BHT to track which short forward conditional branches should be converted, a separate hardware table structure may be provided. The introduction of a separate hardware table structure to identify unpredictable short forward branches can provide a more accurate assessment of branch behavior that outweighs the additional hardware cost since the table structure can be kept relatively small.

FIG. 6 is an exemplary diagram illustrating such a separate hardware table structure in accordance with one illustrative embodiment. As shown in Figure 6, the new short branch misprediction table (SBMT) hardware 610 is coupled to the branch execution unit, such as BRU 470. The BRU 470 may record the prediction history of short forward conditional branches, which are identified as candidates for conversion, in this SBMT 610. As shown in FIG. 6, this information may be stored in saturating counters 640 of the entries in the SBMT 610. The entries in the SBMT 610, in one illustrative embodiment, store an effective address (EA) tag 620, a thread identifier 630, and one or more saturating counters 640.

Using the SBMT 610 of FIG. 6, whenever the BRU 470 evaluates a candidate short forward conditional branch, the BRU 470 accesses the SBMT 610 with the effective address tag, the thread identifier bits, and an indication of whether to increment or decrement the counter, e.g., if the branch is mispredicted, increment the counter, and if the branch is correctly predicted, decrement the counter. The SBMT 610 determines whether there is an entry matching the EA tag and the thread bits and indentifies the result in the match output.

If there is a match, the requested operation is performed on the counter for that entry. The counter is then compared to a threshold value and an indication is generated, if the threshold value is reached. If the threshold is reached, an indication for the decode logic is generated informing the decode logic to convert future occurrences of this branch to non-branching conditional execution instruction sequences comprising a resolve instruction and one or more dependent conditional instructions. This indication may be output by the SBMT hardware 610 to the early decode logic in a similar manner as the special code is provided to the early decode logic from the BHT. In this embodiment, the SBMT would replace the BHT in FIG. 4.

If there is no match, a new entry is created for the supplied effective address (EA) tag and thread bits setting the counter to its initial value. Any least recently used (LRU) algorithm, for example, can be used for determining which entry in the SBMT hardware 610 to replace in such a case.

As an example, three-bit saturating counters may be used with an initial value of ‘100’b and a threshold value of ‘111’b. This results in a threshold hit after at least three more mispredictions than correct predictions occurred within recent executions of the subject branch. The actual number of counter bits, initial value, and threshold values may be determined for specific microarchitectures through simulation, empirical determination, and weighing these settings against the cost of implementation.

The SBMT 610 may be relatively small in size, e.g., 4 entries, because only candidate short forward conditional branches will cause the BRU 470 to access the SBMT 610. The number of bits in the EA tag 620 and counter field 640 may also be fairly small, resulting in an overall small hardware cost for the implementation of the SBMT 610. This small hardware cost allows a significant improvement in the accuracy of branch misprediction history over the use of existing mechanisms (BHT), thus resulting in an overall improvement of the short branch conversion mechanism of the illustrative embodiments. The SBMT 610 approach even allows dynamic variations in implementations where the initial value and threshold for the saturation counters are made programmable.

As noted above, the conversion of short forward conditional branches to non-branching conditional execution sequences of instructions is particularly effective if the original branch cannot be predicted easily. If the branch is highly predictable, no branch redirect penalty can be saved by conversion and thus, conversion may even have a negative impact on performance. It is therefore beneficial to limit the conversion mechanisms of the illustrative embodiments to short forward conditional branches with a high number of mispredictions.

As described above, the illustrative embodiments provide hardware mechanisms to determine the predictability of a short forward conditional branch and determine whether conversion should be performed. However, those hardware mechanisms may have a limited event horizon and may be misled by temporary irregular behavior of a short forward conditional branch. These hardware mechanisms may further be limited by the finite number of entries in the table hardware structures that are used to determine branch behavior.

To aid these mechanisms in determining branch predictability, in further illustrative embodiments, the compiler may have better knowledge of the branch behavior in some cases. For example, a conditional branch to compute the maximum of two values is in many cases hard to predict (assuming random parameters). An even more reliable method of determining branch behavior is runtime profiling of the instructions.

In both these cases a hint can be supplied to the hardware mechanisms for the illustrative embodiments, the hint indicating whether a branch is probably hard to predict or not. Using the POWERPC™ architecture as an example, the conditional branch instruction (bc BO,BI,target_address) may receive a hint from the compiler by using a reserved setting of the “at” bits in the BO field (“01” is currently a reserved value). The hardware of the illustrative embodiments in FIG. 4 would first see this hint bit when it retrieves instructions out of the instruction cache 415. The early decode logic 420, decodes the special hint bit value, and it may automatically convert the short forward conditional branch and its target instruction(s) without consulting the BHT or separate SBMT, depending on the implementation, for predictability. Of course, a second special value of this hint bit value could also be used to suppress conversion independent of the prediction mechanisms of the illustrative embodiments.

Thus, in summary, the hint bit is placed inside the instruction by the compiler when it loads the program code into memory. Referring back to FIG. 4, the instruction is then retrieved from the L2 cache, predecoded, and written into the instruction cache (Icache) as normal. The hardware may then see the hint bit for the first time in the early decode stage where it decodes the branch instruction and finds the special hint bit set. The appropriate action as mentioned above may then take place.

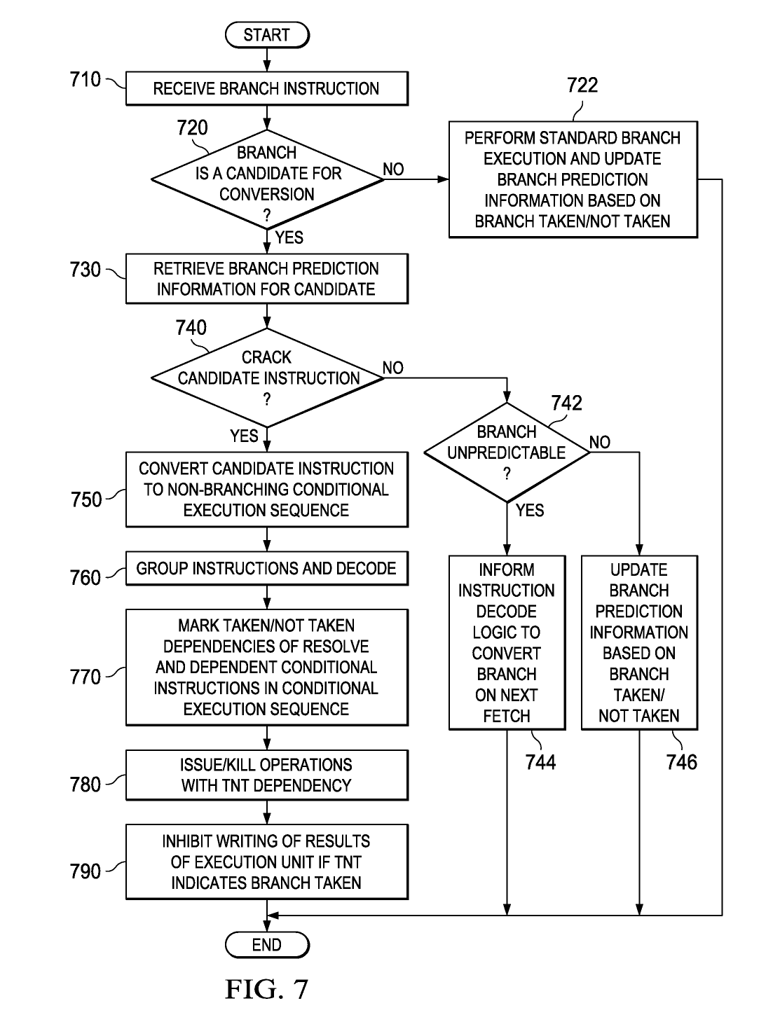

FIG. 7 is a flowchart outlining an exemplary overall operation for handling branch instructions in accordance with one illustrative embodiment. As shown in FIG. 7, the operation starts by receiving a branch instruction (step 710) such as from system memory, an instruction cache, or the like. A determination is made as to whether the branch instruction is a candidate for conversion (step 720). As discussed above, this may be determined by pre-decode logic that has predetermined criteria for identifying short forward conditional branches as candidates for conversion to non-branching conditional execution sequences of instructions, for example. If the branch is not a candidate for conversion, then standard branch execution is performed with branch prediction information being updated based on the prediction made and whether the branch was actually taken or not taken (step 722), e.g., incrementing or decrementing associated saturation counters in the BHT or separate SBMT, for example. The operation then terminates

If the branch is a candidate for conversion, the branch prediction information for the candidate branch is retrieved (step 730). This information may be retrieved from the BHT, from a separate SBMT, or the like, as discussed above. Based on the retrieved information, a determination is made as to whether the candidate instruction should be cracked, i.e. converted to a non-branching conditional execution sequence of instructions comprising a resolve and one or more dependent conditional instructions (step 740). As discussed above, one way in which this determination may be made is to determine whether the branch prediction information retrieved in step 730 comprises a special code indicating that the branch should be cracked.

If the instruction is not to be cracked, a determination is made as to whether the branch is unpredictable (step 742). As discussed above, in one illustrative embodiment, this determination may involve determining if the confidence in the branch is low and the branch is again mispredicted. This can further be determined based on the saturation counter values and a comparison of these saturation counter values to predetermined thresholds.

If the branch is unpredictable, then the instruction decode logic is informed that it is to convert the branch to a non-branching conditional execution sequence in a next fetch of the branch instruction (step 744). One way in which this may be done is to write a special code to an entry in the BHT that is indicative of a need to crack the branch instruction on the next fetch of the branch instruction. If the branch is predictable, then the branch is executed in a standard manner and branch prediction information is updated based on whether the branch was taken or not (step 746).

If the candidate instruction is to be cracked (step 740), then the candidate instruction is converted to a non-branching conditional execution sequence of instructions comprising a resolve instruction and one or more dependent conditional instructions (step 750). These instructions are grouped together and decoded (step 760). Dependencies of the conditional instructions on the resolve instruction are marked (step 770) and operations are either issued or killed based on the taken/not taken dependencies and whether the resolve instruction results in a taken or not taken result (step 780). For those conditional instructions that are issued to execution units, the writing of results of the execution units is inhibited if the TNT bit indicates that the branch is taken (step 790). The operation then terminates.

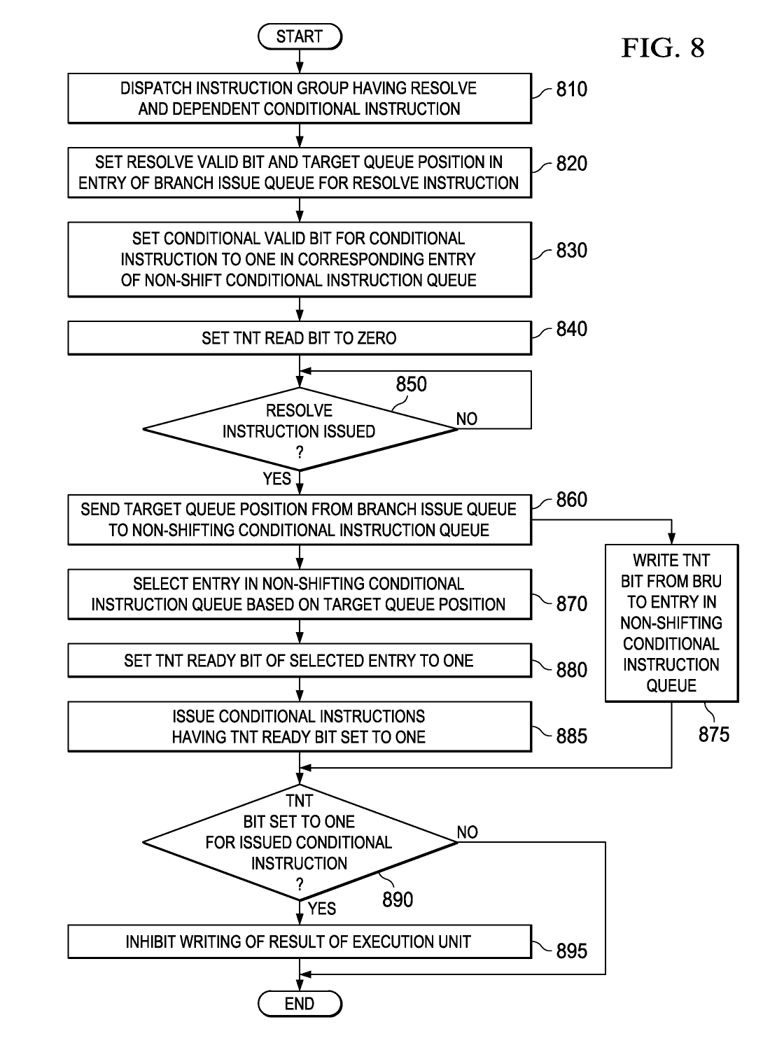

FIG. 8 is a flowchart outlining an exemplary operation for using fields in a branch issue queue and separate non-shifting conditional instruction queue to facilitate sequencing of the resolve and dependent conditional instructions in accordance with one illustrative embodiment. As shown in FIG. 8, the operation starts with the dispatching of an instruction group having resolve and dependent conditional instructions (step 810). The resolve valid bit and target queue position for the resolve instruction are set in a corresponding entry in the branch issue queue (step 820). The conditional valid bit for the dependent conditional instruction(s) is set to 1 in a corresponding entry in the non-shifting conditional instruction queue (step 830). The TNT ready bit is set to 0 (step 840).

A determination is made as to whether the resolve instruction has issued (step 850). If no, the operation waits for the resolve instruction to issue by returning to step 850. If the resolve instruction has issued, then the target queue position in the entry for the resolve instruction is sent from the branch issue queue to the non-shifting conditional instruction queue (step 860). An entry in the non-shifting conditional instruction queue is selected based on the target queue position being used as an index (step 870). At substantially a same time, the taken/not taken (TNT) bit for the resolve instruction is written from the branch execution unit (BRU) to the entry in the non-shifting conditional instruction queue (step 875).

In response to the resolve instruction having issued, the TNT ready bit for the selected entry in the non-shifting conditional instruction queue is set to 1 (step 880). For those conditional instructions having entries in the non-shifting conditional instruction queue that have a TNT ready bit set to 1, the conditional instruction is issued (step 885). A determination is made as to whether the TNT bit is set to 1 for the issued conditional instruction (step 890). If the TNT bit is set to 1 for the conditional instruction, then the writing of the results from the execution unit is inhibited (step 895). The operation then terminates.

Thus, the illustrative embodiments provide mechanisms for improving the processing of unpredictable short forward conditional branches so as to minimize the costs associated with branch misprediction. These costs are avoided by converting the unpredictable short forward conditional branches to non-branching conditional execution sequences of instructions which are not subject to branch misprediction. Moreover, the illustrative embodiments provide hardware mechanisms for identifying and converting such unpredictable short forward conditional branches that minimizes the amount of additional hardware over that of known microprocessor architectures required to implement these mechanisms, thereby minimizing the area and power costs necessary to implement these mechanisms.

As noted above, it should be appreciated that the illustrative embodiments may take the form of an entirely hardware embodiment, an entirely software embodiment or an embodiment containing both hardware and software elements. In one example embodiment, the mechanisms of the illustrative embodiments are implemented in software or program code, which includes but is not limited to firmware, resident software, microcode, etc.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modems and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a processor, for executing a computer code, comprising:
identifying, in pre-decode logic of the processor, a conditional branch in the computer code;
determining, by an instruction dispatch unit of the processor, if the conditional branch is to be converted to a non-branching conditional sequence of instructions;
converting, in decode logic of the processor, the conditional branch to a non-branching conditional sequence of instructions comprising a resolve instruction and one or more conditional instructions dependent on the resolve instruction;
executing, in execution logic of the processor, the non-branching conditional sequence of instructions in place of the conditional branch in the computer code; and
generating, by the processor, an output of the computer code based on the execution of the non-branching conditional sequence of instructions.

2. The method of claim 1, wherein determining if the conditional branch is to be converted to the non-branching conditional sequence of instructions comprises:
determining if an entry, corresponding to the conditional branch, exists in a history data structure;
in response to the entry existing in the history data structure, determining if the entry contains a predetermined value indicating that the conditional branch is to be converted to the non-branching conditional sequence of instructions; and
instructing decode logic of the processor to convert the conditional branch to a non-branching conditional sequence of instructions in response to the predetermined value being present in the entry.

3. The method of claim 2, wherein instructing the decode logic of the processor to convert the conditional branch to a non-branching conditional sequence of instructions comprises setting a “cracked instruction” bit in an instruction buffer entry of an instruction buffer corresponding to the conditional branch.

4. The method of claim 1, further comprising:
in response to the instruction dispatch unit determining that the conditional branch is not to be converted to a non-branching conditional sequence of instructions:
checking a state of one or more saturating counters of an entry, corresponding to the conditional branch, in a history data structure;
determining if the state of the one or more saturating counters meet a predetermined criteria; and
writing a predetermined value to the entry in the history data structure indicating that future encounters of the conditional branch in the computer code are to be converted to the non-branching conditional sequence of instructions.

5. The method of claim 4, wherein the predetermined criteria is that the one or more saturating counters have values indicative of a low confidence in predictability of the conditional branch instruction.

6. The method of claim 4, wherein the history data structure is a branch history table (BHT) data structure and the one or more saturating counters comprise a local predictor BHT counter, a global predictor BHT counter, and a selector predictor BHT counter.

7. The method of claim 1, wherein the predetermined criteria is that the conditional branch has been “not taken” a predetermined number of times previously.

8. The method of claim 1, wherein identifying a conditional branch in the computer code comprises identifying a forward conditional branch that has a number of instructions skipped by a condition of the forward conditional branch that is less than a predetermined conditional branch size value.

9. The method of claim 1, wherein converting the conditional branch to a non-branching conditional sequence of instructions comprises:
converting, by group formation logic of the decode logic, the conditional branch to a conditional execution group of instructions, wherein the conditional execution group of instructions comprises the resolve instruction, corresponding to a conditional branch instruction of the conditional branch, and the one or more conditional instructions dependent on the resolve instruction, corresponding to the conditional instructions of the conditional branch; and
transmitting, by the group formation logic, a signal to an instruction sequencing unit informing the instruction sequencing unit that the group of instructions being sent to the instruction sequencing unit is a conditional execution group of instructions.

10. The method of claim 1, wherein determining if the conditional branch is to be converted to a non-branching conditional sequence of instructions comprises:
determining if a compiler hint bit is set in a conditional branch instruction of the conditional branch, wherein the compiler hint bit indicates whether or not the conditional branch is determined by the compiler to be hard to predict; and
determining that the conditional branch is to be converted to the non-branching conditional sequence of instructions in response to the compiler hint bit being set.

11. A processor, comprising:
pre-decode logic;
an instruction dispatch unit coupled to the pre-decode logic;
decode logic coupled to the instruction dispatch unit; and
execution logic coupled to the decode logic, wherein:
the pre-decode logic identifies a conditional branch in the computer code,
the instruction dispatch unit determines if the conditional branch is to be converted to a non-branching conditional sequence of instructions,
the decode logic converts the conditional branch to a non-branching conditional sequence of instructions comprising a resolve instruction and one or more conditional instructions dependent on the resolve instruction,
the execution logic executes the non-branching conditional sequence of instructions in place of the conditional branch in the computer code, and
the processor generates an output of the computer code based on the execution of the non-branching conditional sequence of instructions.

12. The processor of claim 11, wherein the instruction dispatch unit determines if the conditional branch is to be converted to the non-branching conditional sequence of instructions by:
determining if an entry, corresponding to the conditional branch, exists in a history data structure;
in response to the entry existing in the history data structure, determining if the entry contains a predetermined value indicating that the conditional branch is to be converted to the non-branching conditional sequence of instructions; and
instructing decode logic of the processor to convert the conditional branch to a non-branching conditional sequence of instructions in response to the predetermined value being present in the entry.

13. The processor of claim 12, wherein the instruction dispatch unit instructs the decode logic to convert the conditional branch to a non-branching conditional sequence of instructions by setting a “cracked instruction” bit in an instruction buffer entry of an instruction buffer corresponding to the conditional branch.

14. The processor of claim 11, further comprising:
a branch execution unit coupled to the decode logic, wherein:
in response to the instruction dispatch unit determining that the conditional branch is not to be converted to a non-branching conditional sequence of instructions, the branch execution unit:
checks a state of one or more saturating counters of an entry, corresponding to the conditional branch, in a history data structure;
determines if the state of the one or more saturating counters meet a predetermined criteria; and
writes a predetermined value to the entry in the history data structure indicating that future encounters of the conditional branch in the computer code are to be converted to the non-branching conditional sequence of instructions.

15. The processor of claim 14, wherein the predetermined criteria is that the one or more saturating counters have values indicative of a low confidence in predictability of the conditional branch instruction.

16. The processor of claim 14, wherein the history data structure is a branch history table (BHT) data structure and the one or more saturating counters comprise a local predictor BHT counter, a global predictor BHT counter, and a selector predictor BHT counter.

17. The processor of claim 11, wherein the predetermined criteria is that the conditional branch has been “not taken” a predetermined number of times previously.

18. The processor of claim 11, wherein the pre-decode logic identifies a conditional branch in the computer code by identifying a forward conditional branch that has a number of instructions skipped by a condition of the forward conditional branch that is less than a predetermined conditional branch size value.

19. The processor of claim 11, wherein the decode logic converts the conditional branch to a non-branching conditional sequence of instructions by:
converting, by group formation logic of the decode logic, the conditional branch to a conditional execution group of instructions, wherein the conditional execution group of instructions comprises the resolve instruction, corresponding to a conditional branch instruction of the conditional branch, and the one or more conditional instructions dependent on the resolve instruction, corresponding to the conditional instructions of the conditional branch; and
transmitting, by the group formation logic, a signal to an instruction sequencing unit informing the instruction sequencing unit that the group of instructions being sent to the instruction sequencing unit is a conditional execution group of instructions.

20. The processor of claim 11, wherein the instruction dispatch unit determines if the conditional branch is to be converted to a non-branching conditional sequence of instructions by:
determining if a compiler hint bit is set in a conditional branch instruction of the conditional branch, wherein the compiler hint bit indicates whether or not the conditional branch is determined by the compiler to be hard to predict; and
determining that the conditional branch is to be converted to the non-branching conditional sequence of instructions in response to the compiler hint bit being set.

21. A system, comprising:
a processor; and
a memory coupled to the processor, wherein the processor comprises:
pre-decode logic;
an instruction dispatch unit coupled to the pre-decode logic;
decode logic coupled to the instruction dispatch unit; and
execution logic coupled to the decode logic, wherein:
the pre-decode logic identifies a conditional branch in the computer code,
the instruction dispatch unit determines if the conditional branch is to be converted to a non-branching conditional sequence of instructions,
the decode logic converts the conditional branch to a non-branching conditional sequence of instructions comprising a resolve instruction and one or more conditional instructions dependent on the resolve instruction,
the execution logic executes the non-branching conditional sequence of instructions in place of the conditional branch in the computer code, and the processor generates an output of the computer code based on the execution of the non-branching conditional sequence of instructions.
